(19) United States
(12) Patent Application Publication
(10) Pub. No.: US 2026/0230521 A1
(43) Pub. Date: Aug. 6, 2026

(54) SYSTEMS AND METHODS TO MONITOR TRANSPORT HEALTH AND PERFORM PRIORITY-BASED TRANSPORT SWITCHING WITHIN A COMMUNICATION NETWORK

(71) Applicant: Verkada Inc., San Mateo, CA (US)

(72) Inventor: Simon COUSINEAU, San Mateo, CA (US)

(73) Assignee: Verkada Inc., San Mateo, CA (US)

(21) Appl. No.: 19/465,890

(22) Filed: Jan. 30, 2026

Related U.S. Application Data
(60) Provisional application No. 63/752,485, filed on Jan. 31, 2025.

(51) Int. Cl. H04L 67/104; H04L 43/0811; H04L 67/56

(52) U.S. Cl. CPC H04L 67/104; H04L 43/0811; H04L 67/56

(57) ABSTRACT

A method includes attempting, via a processor of a first compute device and based on a prioritized execution policy, to send data to a second compute device using a first transport associated with a first priority. The method also includes determining, via the processor, that the data was not received at the second compute device. The method also includes attempting, via the processor, in response to determining that the data was not received at the second compute device, and based on the prioritized execution policy, to send the data to the second compute device using a second transport associated with a second priority, the second priority less than the first priority. The prioritized execution policy may be implemented at least in part by a peer-to-peer daemon. The prioritized execution policy references a plurality of transports that includes the first transport, the second transport, and at least one further transport.

### CROSS REFERENCE TO RELATED APPLICATION

This application claims priority to U.S. Provisional Patent Application No. 63/752,485, filed Jan. 31, 2025 and titled “SYSTEMS AND METHODS TO MONITOR TRANSPORT HEALTH WITHIN A COMMUNICATION NETWORK,” the contents of which are incorporated by reference herein in their entirety.

### FIELD

One or more embodiments are related to systems and methods to monitor transport health within a communication network, according to an embodiment.

### BACKGROUND

When peer compute devices have faulty and/or undesirable connections and cannot communicate as desired, data exchange or collaboration is disrupted, leading for example to reduced efficiency, system downtime, or failed processes. Additionally, without monitoring the health of connections between peers, issues such as latency, packet loss, or complete connection failures typically cannot be proactively identified or resolved, compounding reliability problems.

### SUMMARY

In some embodiments, a method includes attempting, via a processor of a first compute device and based on a prioritized execution policy, to send data to a second compute device using a first transport associated with a first priority. The method also includes determining, via the processor, that the data was not received at the second compute device. The method also includes attempting, via the processor, in response to determining that the data was not received at the second compute device, and based on the prioritized execution policy, to send the data to the second compute device using a second transport associated with a second priority, the second priority less than the first priority, the prioritized execution policy being implemented at least in part by a peer-to-peer daemon, the prioritized execution policy referencing a plurality of transports that includes the first transport, the second transport, and at least one further transport.

In some embodiments, a non-transitory, processor-readable medium stores instructions that, when executed by a processor, cause the processor to analyze, at a first compute device, a plurality of connections between a first set of peer compute devices and a second set of peer compute devices based on a target connectivity profile that includes a representation of a predefined number of interface replicas. The instructions also include instructions that, when executed by a processor, cause the processor to cause, based on the target connectivity profile, a modification to an attribute of at least one connection from the plurality of connections.

In some embodiments, a non-transitory, processor-readable medium storing instructions that, when executed by a processor, cause the processor to identify, based on negotiation with at least a second compute device, a prioritized execution policy that includes a representation of a customizable number of interface replicas. The processor-readable medium also stores instructions that, when executed by a processor, cause the processor to attempt, at a first compute device and based on the prioritized execution policy, to send data to the second compute device using a first transport associated with a first priority. The processor-readable medium also stores instructions that, when executed by a processor, cause the processor to determine that the data was not received at the second compute device. The processor-readable medium also stores instructions that, when executed by a processor, cause the processor to attempt, in response to determining that the data was not received at the second compute device, and based on the prioritized execution policy, to send the data to the second compute device using a second transport associated with a second priority, the second priority less than the first priority.

### BRIEF DESCRIPTION OF THE DRAWINGS

FIG. 1 illustrates a block diagram to multiplex across transports and use a prioritized execution policy, according to an embodiment.

FIG. 2 illustrates a block diagram of peer-to-peer (P2P) communication between compute devices, according to an embodiment.

FIG. 3 illustrates a flow diagram of communication between two peer compute devices, according to an embodiment.

FIG. 4 illustrates a block diagram for P2P connections, according to an embodiment.

FIG. 5 illustrates a flow diagram to establish a connection, according to an embodiment.

FIG. 6 illustrates a message egress flow diagram, according to an embodiment.

FIG. 7 illustrates a message ingress flow diagram, according to an embodiment.

FIG. 8 illustrates a flow diagram of a method to attempt establishing a connection using multiple transports, according to an embodiment.

FIG. 9 illustrates a flow diagram of a method to analyze attributes of connections, according to an embodiment.

### DETAILED DESCRIPTION

Some embodiments of the present disclosure are related to attempting to communicate between two compute devices. The compute devices can attempt to communicate with each other by trying out different transports (sometimes referred to herein as “real transport”) until a successful communication is accomplished (or until a successful communication is not established and no transports remain to try). A successful communication might include, for example, data being sent from a first compute device to a second compute device. In some implementations, a “transport” or “real transport” refers to a protocol or mechanism used to transfer data between devices in a communications network. In some implementations, a transport operates at the transport layer or application layer of the Open Systems Interconnection (OSI) model, and provides an ability to deliver packets, streams, and/or messages (successfully or unsuccessfully, depending on the protocol).

When a communication attempt is made between the two compute devices, the sequence / order of transports to be attempted/tried out can be indicated in a policy, such as a prioritized execution policy and/or can be determined based on a target connectivity profile. For example, if a prioritized execution policy indicates that a first transport has a first highest priority and a second transport has a second highest priority, an attempt to send data between the two compute devices can first attempt to send the data using the first transport and only then attempt to send data between the compute devices using the second transport if the first transport is unsuccessful in sending the data. The prioritized execution policy can include a configuration schema having a data format such as JavaScript Object Notation (JSON) or YAML Ain't Markup Language (YAML). Alternatively or in addition, the prioritized execution policy can include a prioritization logic that is built into a system of the present disclosure or that is stored (e.g., exclusively) in a memory of the system, and that is hardcoded, static, imperative and/or deterministic. For example, the prioritization logic can be implemented using one or more finite-state machines (FSMs) defined by associated sets of states, initial states, and inputs that trigger transitions between/among the states. Alternatively or in addition, the prioritized execution policy can be defined based on one or more environmental parameters, one or more runtime flags and/or a startup configuration(s). Alternatively or in addition, the prioritized execution policy can be negotiated, e.g., with one or more peer compute devices. For example, the one or more peer compute devices may exchange messages among themselves and/or with a non-peer compute device, the messages pertaining to details regarding a potential prioritized execution policy, until agreement/consensus on a specific prioritized execution policy is reached. Alternatively or in addition, the prioritized execution policy can be externally managed, e.g., via an Application Programming Interface (API) and by a controller or a manager.

In some implementations, the prioritized execution policy can also indicate desired (e.g., acceptable, ideal, standard, predetermined) parameters/attributes, such as connectivity states. For example, for each of the transports listed in the prioritized execution policy, one or more desired connectivity states can also be listed. Actual connectivity states can then be compared to the desired connectivity states, and actions can be taken based on these comparisons of actual and desired connectivity states. For example, if a connection between two compute devices using a transport does not have the desired connectivity states—as indicated in the prioritized execution policy—a remedial action can occur (e.g., create a new connection, close the connection, generate an alert, and/or the like).

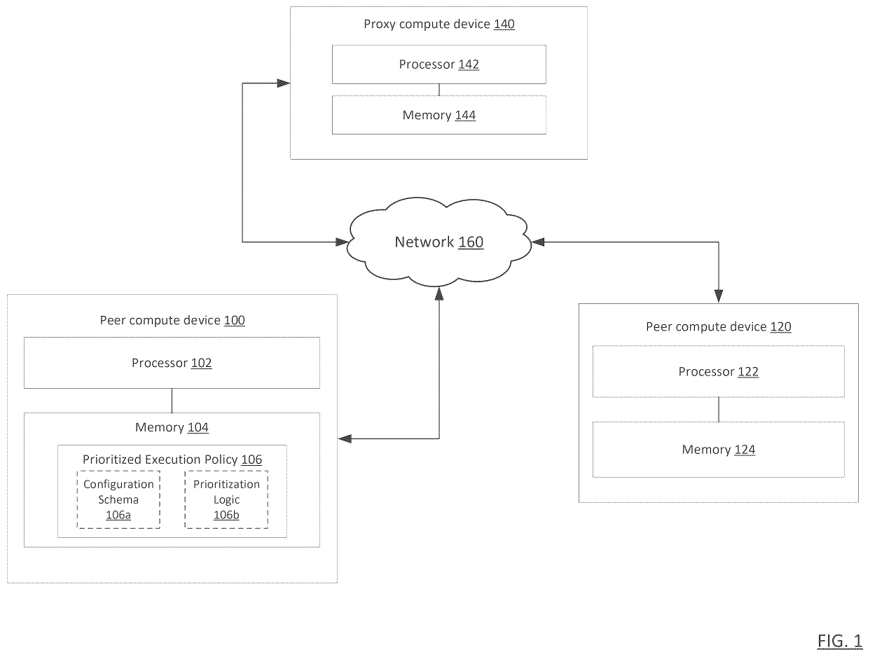

FIG. 1 illustrates a block diagram of a system to multiplex across transports and use a prioritized execution policy, according to an embodiment. FIG. 1 includes peer compute device 100, peer compute device 120, and proxy compute device 140, each communicatively coupled to one another via network 160. Peer compute device 100, peer compute device 120, and proxy compute device 140 can each be any type of compute device, such as a server, desktop, laptop, tablet, phone, internet of things (IOT) device, and/or the like. In some implementations, the proxy compute device 140 is or includes a compute device that is configured to perform signaling.

Network 160 can be any suitable communications network for transferring data, for example, operating over public and/or private communications networks. For example, network 160 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, network 160 can be a wireless network such as, for example, a Wi-Fi® or wireless local area network (“WLAN”), a wireless wide area network (“WWAN”), and/or a cellular network. In other instances, the network 160 can be a wired network such as, for example, an Ethernet network, a digital subscription line (“DSL”) network, a broadband network, and/or a fiber-optic network. In some instances, network 160 can use Application Programming Interfaces (APIs) and/or data interchange formats, (e.g., Representational State Transfer (REST), JavaScript Object Notation (JSON), Extensible Markup Language (XML), Simple Object Access Protocol (SOAP), and/or Java Message Service (JMS)). The communications sent via network 160 can be encrypted or unencrypted. In some instances, the network 160 can include multiple networks or subnetworks operatively coupled to one another by, for example, network bridges, routers, switches, gateways and/or the like.

Processor 102 can be operatively coupled to memory 104, processor 122 can be operatively coupled to memory 124, and processor 142 can be operatively coupled to memory 144 (e.g., each via a system bus). Processor 102, 122, and/or 142 each can be, for example, a hardware-based integrated circuit (IC) or any other suitable processing device configured to run and/or execute a set of instructions or code. For example, processor 102, 122, and/or 142 each can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, processor 102, 122, and/or 142 can be configured to run any of the methods and/or portions of methods discussed herein.

Memory 104, 124, and/or 144 each can be, for example, a random-access memory (RAM), a memory buffer, a hard drive, a read-only memory (ROM), an erasable programmable read-only memory (EPROM), and/or the like. Memory 104, 124, and/or 144 can be configured to store any data used by processor 102, 122, and/or 142, respectively, to perform the techniques (methods, processes, etc.) discussed herein. In some instances, memory 104, 124, and/or 144 can store, for example, one or more software programs and/or code that can include instructions to cause processor 102, 122, and/or 142, respectively, to perform one or more processes, functions, and/or the like. In some implementations, memory 104, 124, and/or 144 can include extendible storage units that can be added and used incrementally. In some implementations, memory 104, 124, and/or 144 each can be a portable memory (for example, a flash drive, a portable hard disk, a SD card, and/or the like) that can be operatively coupled to processor 102, 122, and/or 142, respectively. In some instances, memory 104, 124, and/or 144 can be remotely operatively coupled with a compute device (not shown in FIG. 1). In some instances, memory 104, 124, and/or 144 is a virtual storage drive (e.g., RAMDisk), which can improve I/O speed and in turn, accelerate image reading and writing.

Memory 104 can include (e.g., store) a prioritized execution policy 106 (optionally including a configuration schema 106a and/or prioritization logic 106b). Prioritized execution policy 106 can include a representation of one or more real transports and their priorit(ies) (e.g., absolute priority and/or relative priority) when attempting to establish a connection between peer compute devices 100 and 120. Said differently, when peer compute devices 100 and/or 120 are attempting to establish a connection with each other, prioritized execution policy 106 can indicate which transports to try and in what order to try those transports. For example, prioritized execution policy 106 can indicate that a real-time communication data channel transport (e.g., WebRTC data channel transport) is to be attempted first, a transport that uses multicast domain name system (mDNS) and hypertext transfer protocol secure (HTTPS) is to be attempted second, and a websocket proxy transport which proxies (e.g., relays) all messages through a backend compute device is to be attempted third. Examples of transports include, but are not limited to, a user datagram protocol (UDP), a transmission control protocol (TCP), a steam control transmission protocol (SCTP), one or more multi-media transports such as real-time transport protocol (RTP) or session initiation protocol (SIP), and/or the like.

Therefore, in an example, peer compute device 100 can initiate a connection to peer compute device 120. Said differently, peer compute device 100 can attempt to establish a communication with peer compute device 120. In response, an attempt is made (e.g., by peer compute device 100 and/or 120) to establish a connection between peer compute devices 100 and 120 based on prioritized execution policy 106 by attempting to establish communication using the transports indicated in prioritized execution policy 106 in the order indicated by prioritized execution policy 106. For example, if prioritized execution policy 106 indicates that transport A has highest priority and transport B has second highest priority, an attempt is first made to establish a connection between peer compute devices 100 and 120 using transport A (where transport A is a first type of transport and transport B is a second type of transport different than transport A); if a connection is not made using transport A (e.g., peer compute device 100 could not send data to peer compute device 120 and/or peer compute device 120 did not receive data from peer compute device 100), and in response to the connection not being made using transport A, an attempt is (e.g., automatically) subsequently made (e.g., by peer compute device 100 and/or 120) to establish a connection between peer compute devices 100 and 120 using transport B. Such a process of trying to establish a connection between peer compute devices 100 and 120 can occur until (1) a connection is successfully established or (2) all transports listed in prioritized execution policy 106 have been attempted but a connection has not successfully been established. In some implementations, a compute device (e.g., peer compute device 100 or 120) attempts to establish a communication with a compute device (e.g., the other of peer compute device 100 or 120) using multiple transport types at the same time (e.g., concurrently or overlapping in time, instead of in sequential order); once a connection has been established, however, the sequential ordering can be enforced for sending messages between the compute devices.

If a connection is not established (e.g., after each transport listed in prioritized execution policy 106 has been attempted), a remedial action can occur/be triggered. For example, an alert can be generated at a compute device (e.g., peer compute device 100, peer compute device 120, proxy compute device 140, a compute device not shown in FIG. 1, etc.). As another example, a compute device (e.g., peer compute device 100, peer compute device 120, a compute device not shown in FIG. 1, etc.) can send (or cause to be sent) a signal representing a request (e.g., to proxy compute device 140 and/or a compute device not shown in FIG. 1) for an updated prioritized execution policy (e.g., listing different transports). As another example, a compute device (e.g., peer compute device 100 and/or 120) can attempt to bypass network address translation (NAT) restrictions or firewalls using one or more techniques such as interactive connectivity establishment (ICE). As another example, a compute device (e.g., peer compute device 100 and/or 120) can switch to an offline mode or a cached mode. As another example, a compute device (e.g., peer compute device 100 and/or 120) can perform diagnostics to diagnose the issue(s) causing the failure(s).

Prioritized execution policy 106 can also indicate one or more desired (e.g., acceptable, ideal, standard, predetermined, preferred, predefined, customized, user-selected, etc.) attributes for each transport listed in the prioritized execution policy 106. The desired attributes can collectively be referred to as a target connectivity profile. For example, if prioritized execution policy 106 includes transport A and transport B, prioritized execution policy 106 can also indicate desired attributes (e.g., connectivity profiles) of transport A and transport B. Examples of attributes can include, but are not limited to, connectivity state (e.g., a target connectivity state), a number of connections, latency, bandwidth, error rate, encryption level, configuration parameters, a last response time, and/or the like. By using the desired attributes listed in prioritized execution policy 106 as a standard/target, the actual connection between peer compute devices 100 and 120 can be evaluated. For example, if peer compute devices 100 and 120 are connected via transport A, the connection between peer compute devices 100 and 120 using transport A can be analyzed to determine if that connection is compatible, based on the associated attribute(s), with transport A in prioritized execution policy 106.

In some implementations, if a connection between peer compute devices 100 and 120 does not have the desired attributes indicated for the connection in prioritized execution policy 106, one or more remedial actions can occur/be triggered. For example, the connection can be blocked/closed, the connection can be re-established, a different connection can be attempted using a different transport according to prioritized execution policy 106, a different connection can be attempted using the same transport, and/or the like.

In some implementations, prioritized execution policy 106 is updated repeatedly (e.g., continuously, periodically, intermittently, sporadically, according to a schedule, etc.). For example, prioritized execution policy 106 can be updated to change transports listed in prioritized execution policy 106, change the priority indicated for one or more listed transports, modify desired attributes of the transports, and/or the like.

In some implementations, prioritized execution policy 106 is generated by a user. For example, a user can indicate what transports to try, a priority of the transports, and desirable attributes of those transports during connection. Additionally or alternatively, prioritized execution policy 106 can be generated automatically by a computer (e.g., with default transports to try, a priority of those transports, and/or desirable attributes of those transports during connection); in some implementations, prioritized execution policy 106 is generated by a computer in response to a peer compute device (e.g., peer compute device 100) turning on, attempting to send data, attempting to connect to another compute device, establishing a connection to network 160, and/or the like. Additionally or alternatively, prioritized execution policy 106 can be included in a peer compute device 100 and/or peer compute device 120, as a built-in default (e.g., stored in a memory thereof). Additionally or alternatively, prioritized execution policy 106 can be defined and/or controlled by a centralized processor or server (e.g., proxy compute device 140) and distributed/“pushed” to multiple devices (e.g., peer compute device 100 and/or peer compute device 120) by the centralized processor or server. Additionally or alternatively, prioritized execution policy 106 can be received/“pulled” from a centralized processor or server (e.g., proxy compute device 140) by a peer compute device 100 and/or peer compute device 120 by requesting the prioritized execution policy 106 therefrom. Additionally or alternatively, prioritized execution policy 106 can be exchanged or distributed via “inter-peer” negotiation/communication (e.g., between or among peer compute device 100, peer compute device 120 and/or proxy compute device 140).

In some implementations, proxy compute device 140 is configured to make and/or monitor connections between peer compute devices. For example, proxy compute device 140 can assist peer compute device 100 to discover a network address of peer compute device 120 (or vice versa). Alternatively or in addition, the proxy compute device 140 can be configured to exchange connection information with one or more peer compute devices. As another example, proxy compute device 140 can be a connection broker that negotiates the connection parameters between peer compute devices 100 and 120. As another example, one peer compute devices 100 and 120 have established a connection using a transport, proxy compute device can monitor parameters of the transport. In some implementations, proxy compute device 140 facilitates connection establishment between peer compute devices (e.g., peer compute devices 100 and 120) and/or proxies messages through the Internet when local network rules restrict direct connections with/to the peer compute device. In some implementations, proxy compute device 140 performs device authentication, for example, by facilitating a certificate exchange to authenticate peer compute device (e.g., peer compute device 100 and 120). In some implementations, peer compute devices 100 and 120 each provide a certificate to proxy compute device 140, and proxy compute device 140 verifies the certificates (e.g., that the certificate are signed by a trust certificate authority, not expired, etc.). In some implementations, proxy compute device 140 collects metrics and statistics to monitor connection health; proxy compute device 140 can collect these metrics and statistics instead of or in addition to peer compute device 100 and/or 120.

Although FIG. 1 illustrates three compute devices, in other implementations, more or less compute devices can be used. For example, in some implementations, functionalities of proxy compute device 140 can be combined with peer compute device 100 and/or 120. As another example, although FIG. 1 discussed establishing and monitoring a connection between two peer compute devices, in other implementations, any number of connections can be made for any number of peer compute devices.

Some implementations are related to managing multiple connections of different types over a single logical connection to a given peer compute device (e.g., peer compute device 100 and/or 120). These single logical connection can be multiplexed across a set of real transports (e.g., as listed in prioritized execution policy 106), which can use different protocols. Some implementations are related to managing multiple logical connections of different types over a single physical connection to a given peer compute device (e.g., peer compute device 100 and/or 120). These multiple logical connections can be multiplexed across a set of real transports (e.g., as listed in prioritized execution policy 106), which can use different protocols. When a compute device (e.g., peer compute device 100 and/or 120) is attempting to send a message to a peer compute device (e.g., peer compute device 100 and/or 120) through the logical connection, the compute device can attempt to send the message to the peer compute device using the real transports (in priority order) until one of them is successful. Each transport can be configured independently (e.g., each transport operates without requiring information or coordination from other transports to function properly), and each transport also can be individually monitored (e.g., by peer compute device 100 and/or 120) for health throughout the lifetime of the logical connection.

When a compute device (e.g., peer compute device 100 and/or 120) requests to connect with a peer compute device (e.g., the other of peer compute device 100 and/or 120), the transports that make up the logical connection can be established and configured (e.g., according to prioritized execution policy 106). These transports can conform to a common interface, which allows a connection manager (e.g., a module at peer compute device 100 and/or 120) to manage and interact with each transport using a standard application programming interface (API). The API can include, for example, ‘GetState( )’, ‘Send( . . . )’, ‘Connect( )’, ‘Close( )’, and/or the like. In some implementations, the compute device (e.g., peer compute device 100 and/or 120) includes a pubsub module. In some such implementations, the pubsub module implements logic to create and manage subscriptions to/from other compute device (e.g., peer compute device 100 and/or 120, a peer compute device not shown in FIG. 1), using the logical peer-to-peer connections to transmit data. In some implementations, a calling process (e.g., a business logic process) at a first compute device (e.g., peer compute device 100 and/or 120) requests a subscription against a second peer compute device (e.g., the other of peer compute device 100 and/or 120), which may be created and managed by the pubsub module, and the pubsub module may in turn transmit the subscription payload to the second peer compute device using the logical connection. The second peer compute device can then publish events that may be routed back through the pubsub module and back to the calling process at the first compute device through the logical connection (and underlying real transport(s)). In some implementations, the compute device (e.g., peer compute device 100 and/or 120) includes an RPC request/response module (e.g., to implement remote procedure call APIs). In some implementations, the compute device (e.g., peer compute device 100 and/or 120) includes a file transfer module configured to exchange files between compute devices (e.g., the other of peer compute device 100 and/or 120) using the logical connection.

The transports can be implemented using different protocols and technologies, which the connection manager (e.g., a module at peer compute device 100 and/or peer compute device 120) can manage and interact with using one or more APIs. In some implementations, a peer-to-peer communication daemon uses (but is not limited to) one, two, or all three of the following transports: a proxy (such as a websocket proxy server, a TURN server, a relay server, a cloud gateway and/or an overlay network) which proxies all messages through a backend compute device; a peer-to-peer (“P2P”) (optionally real-time) communication data channel transport (e.g., WebRTC data channel transport, QUIC/HTTP3, raw Transmission Control Protocol (TCP)/User Datagram Protocol (UDP) channels, etc.); and a local discovery transport that uses multicast domain name system (mDNS) and hypertext transfer protocol secure (HTTPS) (e.g., a mDNS+HTTPS transport, which uses mDNS to discover the peer compute device's internet protocol (IP) address and then communicates using HTTPS requests with mutual transport layer security (mTLS) authentication), Simple Service Discovery Protocol (SSDP), Address Resolution Protocol (ARP) based discovery, or wireless discovery (e.g., Bluetooth®, sub-GHz radio, Near Field Communication (NFC), etc.).

The transport options described herein can allow peer compute devices 100 and 120 to connect using alternative protocols/networks (e.g., via network 160 and/or one or more other networks which may include a wireless network). As such, peer compute device 100 could communicate with peer compute device 120 by various means, for example directly (peer-to-peer) via network 160 (either locally on a local area network (LAN), or across networks using network address translator (NAT) traversal or similar techniques), via a proxied/relayed connection through proxy compute 140, through a wireless communication protocol (not pictured in FIG. 1), etc. A transport option could also include a direct connection(s) (i.e., a wire run directly between peer devices, such as an ethernet cable or RS485). The transport options can be thought of as the arrows that connect the peer compute devices to the network (e.g., a network box(es)) and then to one another (or through multiple different networks, or directly).

In some implementations, when a compute device (e.g., peer compute device 100 and/or 120) attempts to send a message to the peer compute device (e.g., peer compute device 100 and/or 120), transports are attempted in priority order (e.g., the priority order determined by prioritized execution policy 106). If the compute device, using a transport, fails to send the message, the next, lower-priority transport will be tried until the message is successfully delivered or all transports have tried and failed.

Some implementations are related to managing the way a peer-to-peer (P2P) communication daemon handles connection lifecycle management such that an integrator (e.g., a module at peer compute device 100 and/or 120) can more easily define a desired connection state to peer compute devices. The connection state to each peer compute device can be described using a policy (e.g., prioritized execution policy 106), which outlines the “desirable,” “acceptable,” and/or “perfect” connectivity state to achieve. This connection state, or connectivity state, can include different interface types, such as proxy connections (e.g., a backend proxy server, a websocket proxy server, a TURN server, a relay server, a cloud gateway and/or an overlay network) and/or P2P connections (e.g., WebRTC data channel transport, QUIC/HTTP3, raw TCP/UDP channels, mDNS and HTTPS). Additionally or alternatively, the connectivity state can include details about mesh networks and/or details about using other nodes in a network to relay messages to peers, for example in situations where direct connection isn't possible/feasible or desirable (e.g., repeating messages for wireless devices that are out of range, through an intermediate node within range of both a target and a destination, multi-jump routing, etc.). Additionally or alternatively, each interface can be configured independently with customizable (e.g., user defined) parameters, including the number of interface replicas desired (e.g., Primary and Fallback connections that will failover). A core connection manager (e.g., a module at peer compute device 100 and/or 120) can automatically (e.g., without human intervention) populate connections of each desired type, configure the interfaces, and manage the health (e.g., monitoring connection status, error detection and/or handling, load balancing, connection recovery, health metric connection like latency or jitter, and/or the like) of all incoming/outgoing connections based on the prioritized execution policy. In some implementations, “P2P” does not refer to a sharing of resources (e.g., memory, processor power, etc.); instead, “P2P” can refer to an edge-to-edge communication technique where a first edge device can initiate the connection process with a second edge device, and where the first and second edge devices can work together to identify a best/desirable/preferred protocol, or a plurality of best/desirable/preferred protocols to use with one another. In some implementations, multiple edge devices or peer devices can agree on multiple protocols among which the multiple edge devices or peer devices might switch to/among, depending on connectivity metrics. For example, the multiple edge devices or peer devices may “agree,” or determine via consensus, that a first transport protocol is most preferred, and begin using that first transport at a first time, then at a second time subsequent the first time, in response to detecting a degradation in the first transport protocol, the multiple edge devices or peer devices (or a subset thereof) may collectively switch over to a next (second) transport protocol in a set of priority-ranked transport protocols previously agreed upon by the multiple edge devices or peer devices.

In some implementations, a policy, such as a prioritized execution policy or a schema, is generated, updated, and/or maintained that includes interface definitions, such as each interface's configuration parameters. In some implementations, a default prioritized execution policy is bundled with the daemon, although in some implementations a custom policy may be written (e.g., by a user and/or computer) to the filesystem (e.g., of peer compute device 100 and/or 120). The daemon can repeatedly (e.g., continuously, periodically, sporadically) update the policy at runtime using the policy loaded from a disk (e.g., a hard disk drive). In some implementations, the core connection manager automatically (e.g., without human intervention) monitors and manages connections based on this policy. The core connection manager can repeatedly (e.g., periodically, continuously, sporadically) perform a health-check during which the core connection manager can perform at least one of the following:
1. populate a desired number of connections of each type, according to a prioritized execution policy;
2. configure each new connection according to the configuration parameters defined in the prioritized execution policy;
3. start new connection interfaces;
4. probe and measure health metrics of all existing connections; and/or
5. audit and prune closed or failed connection interfaces.

Some implementations are related to, or include, a peertopeerd daemon, which provides a stable and easy-to-use P2P transport layer for cross-device features. In some implementations, a peertopeerd daemon refers to a background software program or process that facilitates and manages communication, data exchange, or network activities in a P2P network. In some implementations, P2P networks include decentralized interactions between devices (peers) without relying on a central server. In some implementations, “peerdtopeerd” refers to software and/or hardware that facilitates establishing and/or monitoring a connection between a pair of peer compute devices based on a prioritized execution policy. In some implementations, peertopeerd represents code to be executed by a processor of a peer compute device, such as peer compute device 100 and/or 120. While some implementations of the present disclosure are or include a standalone daemon(s)/background process, other implementations can be or include code that is included as part of a larger compute process.

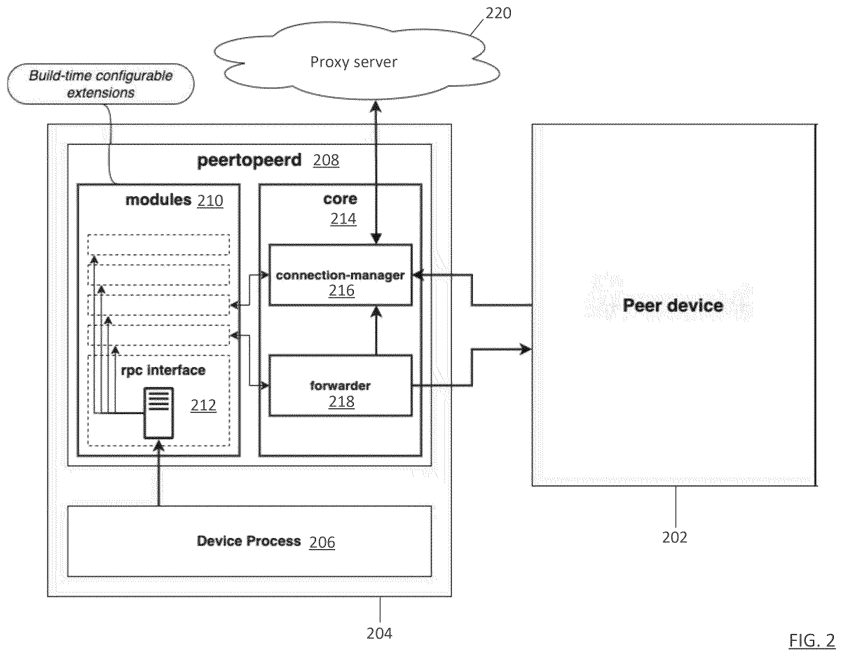

FIG. 2 illustrates a block diagram of P2P communication between compute devices, according to an embodiment. In some implementations, compute device 204 is similar in structure and functionality to peer compute device 100, and/or peer device 202 is similar in structure and functionality to peer compute device 120. Although not explicitly shown in FIG. 2, in some implementations, compute devices 204 and 202 can be communicatively coupled to one another via a network (e.g., network 160). Further, although not explicitly shown in FIG. 2, a prioritized execution policy (e.g., prioritized execution policy 106) can be stored at and used by any of the modules at compute device 204 and/or 202.

A core module 214 of a compute device 204 can be configured to handle connection management (e.g., using connection manager 216) and message forwarding (e.g., using forwarder 218) with other devices (e.g., peer device 202), while other modules 210 of the compute device 204 can be configured to provide/include a remote procedure call (RPC) interface 212 (sometimes referred to herein as “RPC interface module”), publish-subscribe (pub-sub) communications, and/or request/response communications. In some implementations, peertopeerd is built and/or integrated with other device processes 206, as described herein.

### Architecture

In some implementations, peertopeerd uses build-time configurable modules to determine a set of functionalities that are built into the daemon. These functionalities can provide additional interfaces and connections models. The core module 214 can manage message forwarding (e.g., using forwarder 218) and peer connections (e.g., using connection manager 216), including the establishment of new/additional connections through a proxy server 220 (e.g., proxy compute device 140), with a peer device (e.g., peer device 202). The proxy server 220 can maintain a connection (e.g., persistent connection) with a P2P-enabled device(s), such as compute device 204 and peer device 202, allowing the P2P-enabled device(s) to proxy websocket messages used for connection creation.

In some implementations, the proxy server connection is not used to maintain a peer connection(s) after the peer connection(s) has been established. Connections between peertopeerd daemons can persist even if either or both devices lose connection to a network (e.g., public internet).

### Modules

In some implementations, the core module (e.g., core 214) handles aspects to establish, maintain, and manage connections and communication; this can include connection management (e.g., via connection manager 216) and message routing/forwarding between the host and peer (e.g., via forwarder 218). In some implementations, peertopeerd uses other modules (e.g., accessory modules that make using connections established by the core module easier) to enable and/or disable one or more features and/or interfaces at build-time. These features and/or interfaces can be configured using the associated build tag, which can determine which modules are built and started. For example, other modules can include the pubsub module that make creating subscriptions against peer devices by managing the exchange of subscription and routing messages appropriately easier for the integrator. As another example, other modules can include modules that facilitate making RPC (e.g., Google® remote procedure call) calls against peer devices through the secure channels established between the peer compute devices; said differently, RPC calls can be made to peer devices (e.g., instead of inter-process communication). In some implementations, rpc interface 212 communicates between processes on a single device (e.g., inter-process communication on compute device 204). As another example, other modules can include a module configured to provide utilities to perform file transfer protocol (FTP).

### Core

In some implementations, the core module handles connection management and message forwarding. The connection manager can maintain a connection with the proxy server (e.g., proxy compute device 140) to establish new/additional connections and track the connection state of peer devices. A forwarder can handle synchronous and/or asynchronous message forwarding. In some implementations, an RPC interface module provides, for example, at least the APIs to interface with the core module:
ConnectToPeer
IsConnected
EnsureConnected RPC Interface—p2p_rpc_interface In some implementations, the RPC interface module 212 provides (e.g., is located at, is communicatively coupled to) an RPC server (e.g., a compute device not shown in FIG. 1), allowing other processes to interface with peertopeerd. In some implementations, the RPC server runs on “localhost:929,” and can be interfaced from any language that supports RPC calls. In some implementations, the RPC module also provides a Golang client package which wraps these RPC client calls in a simple to use interface.

Supported RPC methods can be defined in each respective module section.

### PubSub Message (or Messaging) Module—p2p_message

In some implementations, a message module (e.g., located at peer compute device 100 and/or peer compute device 120), such as message queuing telemetry transport (MQTT), provides pub-sub communications between peer devices. A subscribing device (e.g., peer compute device 100 and/or 120) can create a filter for selecting the events and/or messages to which the peer device is to subscribe. A representation of the filter is then sent to the publishing device (e.g., peer compute device 100 and/or 120), where peertopeerd will listen to the message module for events matching the filter on the specified topic. All matched events can be forwarded back to the subscriber, where they can be published to the local message process.

In some implementations, the RPC interface module provides at least one or more of the following helpers to interface with the message module:
SubscribeToPeer (peer string, topic string, filter*protofilter.Protofilter) error

For example, a subscription to keycard events for a given door port on a peer device can be created as:
pf=protofilter.New(&communication. SubsystemEvent{ },
protofilter.WithString(“device_id”).Matching(peerDeviceID),
protofilter.WithFieldPresent(“keycard_reading.keycard_number”),
protofilter.WithInt32(“keycard_reading.door_index”).Matching(doorIndex),
err=peertopeer.SubscribeToPeer(peerDeviceID, topicToListenToOnPeer,
topicToDispatchToLocally, pf)

### RPC Bridge—p2p_rpc_bridge

In some implementations, the RPC bridge module (e.g., located at peer compute device 100 and/or 120) provides request/response communications between peer devices. The module can provide an RPC outterface which allows peertopeerd to make RPC calls on peer devices against “localhost.” This allows cross-device RPC calls, without opening additional ports to the public internet.

The RPC bridge module can provide, for example, at least the following helper to interface with the RPC Bridge module:
CallPeerRPC(peer string, port int, method string, timeout time.Duration, payload [ ]byte) (responsePayload [ ]byte, err error)

For example, the “Subsystem.BlinkLED” method on “peer-device-2” can be called while the RPC server running on localhost:4003 with a two second timeout as:
peertopeer.CallPeerRPC(“peer-device-2”, 4003, “Subsystem.BlinkLED”, 2* time.Second, [ ]byte{ })//TODO: Handle response and error

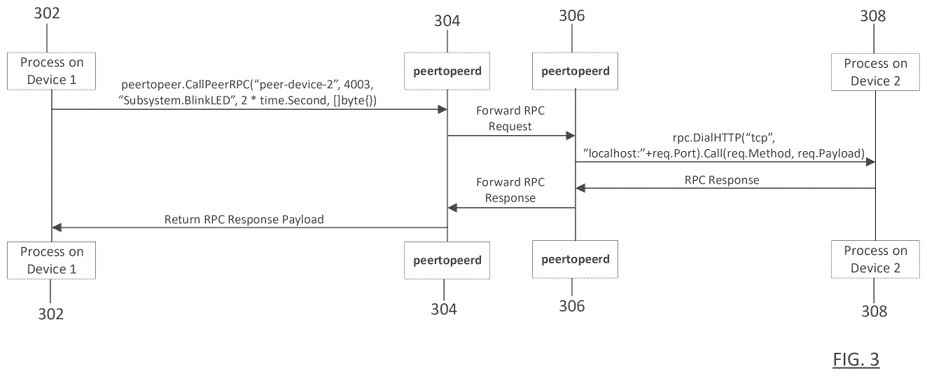

FIG. 3 illustrates a flow diagram of communication between two peer compute devices, according to an embodiment. In some implementations, process on device 1 302 and peertopeerd 304 represent code at a first compute device (e.g., peer compute device 100 and/or 120), and process on device 2 308 and peertopeerd 306 represent code at a second compute device (e.g., peer compute device 100 and/or 120). In some implementations, process on device 1 302, peertopeerd 304, process on device 2 308, and peertopeerd 306 are each separate modules (e.g., each self-contained units of code that performs a specific function or set of functions and can be independently developed, tested, and reused).

Process on device 1 302 sends a “peertopeer. CallPeerRPC(‘peer-device-2”, 4003, “Subsystem.BlinkLED”, time.Second, [ ]byte[ ]) command to peertopeerd 304. In response, peertopeerd 304 forwards the RPC request to peertopeerd 306. In response, peertopeerd 306 dials the local RPC server and calls the requested method/command to process on device 2 308. In response, process on device 2 308 send the RPC response to peertopeerd 306, and peertopeerd 306 forwards the RPC response to peertopeerd 304. Peertopeerd 304 then returns the RPC response payload to process on device 1 302.

Note that this allows methods to be called on the local RPC server running on “peerdevice-2” without opening port “4003” to the internet.

### File System Interface—p2p_fs_interface

The file system interface module (e.g., located at peer compute device 100 and/or 120) provides an interface for making connections to peer devices. When enabled, the file system interface can read the contents of “/mnt/config/p2p_config.json” and make a connection to all specified peers. This module can be used for, for example, debugging.

The JSON can follow the following format:
{“peers”: [“peer1-device-id”, “peer2-device-id”]}

### Ping—Disable with p2p_no_ping

In some implementations, a ping module (e.g., located at peer compute device 100 and/or 120) is built in by default, but can be disabled with the “p2p_no_ping” flag. The ping module allows the caller to ping a peer device through peertopeer. The ping module can be used for, for example, debugging.

The RPC interface module can provide the following helper to interface with the Ping module:
PingPeer(peer string) error

### Building

### Standalone

In some implementations, peertopeerd can be implemented as a standalone process.

### Part of Another Process

Peertopeerd can be integrated into another process (e.g., a main process). This integration allows interfacing with peertopeerd functions directly (e.g., without using the RPC interface and the RPC interface's client). The interfacing process is similar for starting the peertopeerd Core (e.g., start a goroutine for the “Main( )” entry point).

Some implementations measure connection performance/health. In some implementations, connection performance/health is used to automatically (e.g., without user intervention) take actions to return the overarching “logical connection” back to a healthy and/or predetermined state.

In some implementations, the “logical connection” is made up of multiple transport connections, each which may be using a different network protocol. By monitoring the health of each connection, failing connections can be closed and new connection ones can be created to replace failing connections. The transport creation/deletion process aims to return the logical connection state to its ideal/desired state, as described by the connection policy (e.g., prioritized execution policy 106) outlining the desired configurations and replication for each transport. In some implementations, transports are prioritized and/or updated at run time.

Some implementations described herein have the advantage that transport priority is deterministic and the configuration can be updated at runtime since the updated policy can be reflected substantially immediately.

In some implementations, rather than using link-layer redundancy and/or working at the link layer, transport/application layer redundancy and/or aggregated heterogenous application/transport layer protocols are used.

In some implementations, rather than a system that strictly deals with redundancy of identical resources, a system can support transports of different kinds and redundancy of each type. For example, the logical connection can be composed of a Primary WebRTC data channel, a Backup WebRTC data channel, an HTTPS “channel,” a websocket proxy channel, and/or the like.

In some implementations, techniques described herein can: use any protocol; do not perform link aggregation; be protocol specific and not use retransmission (e.g., try a different interface or protocol upon failure as described herein); interface to application; are not standardized (though the protocols used can be standardized); be cross-platform; and use end-to-end encryption, mTLS, and/or general mutual authentication (e.g., datagram transport layer security (DTLS) or TLS over UDP).

Techniques described herein are not a system for multiplexing the same connection to ICE endpoints using a proxy server (which uses a self-registered proxy system where endpoints can register themselves using a randomly generated username). Instead, some implementations multiplex one or more logical connections to a given peer compute device onto a composite connection that uses one or more real transport connections. The multiplexing happens at the logical level (e.g., and not multiplexing a connection to a given host, like an ICE endpoint).

In some implementations, ICE can be used for WebRTC connections, but the ICE protocol is not used to send a description of multiple connection methods or support codexes to a peer before establishing a connection. Instead, in some implementations, multiple connections to a given peer are used. ICE can evaluate each option and select the best path, whereas some techniques described herein establish each transport connection to the peer and keep them all open. Traffic is then routed through the appropriate interface (in priority order), trying the next interface if a failure occurs. Thus, the selection of “best” interface is done at message sending time, based on which interfaces succeed in transmitting the message, instead of at connection establishment time like ICE; this provides more flexibility since multiple transports can be opened and maintained, making multiple transports available at send time even in the face of random network faults that may not be present at connection establishment time.

Some implementations provide reliability through redundancy, but at a higher level compared to some known techniques. For example, for protocols that stream data or use sessions, disruptions could cause that transport to be unavailable for data transmission. Techniques described herein allow the data to instead be sent using a different protocol/transport during transient failures.

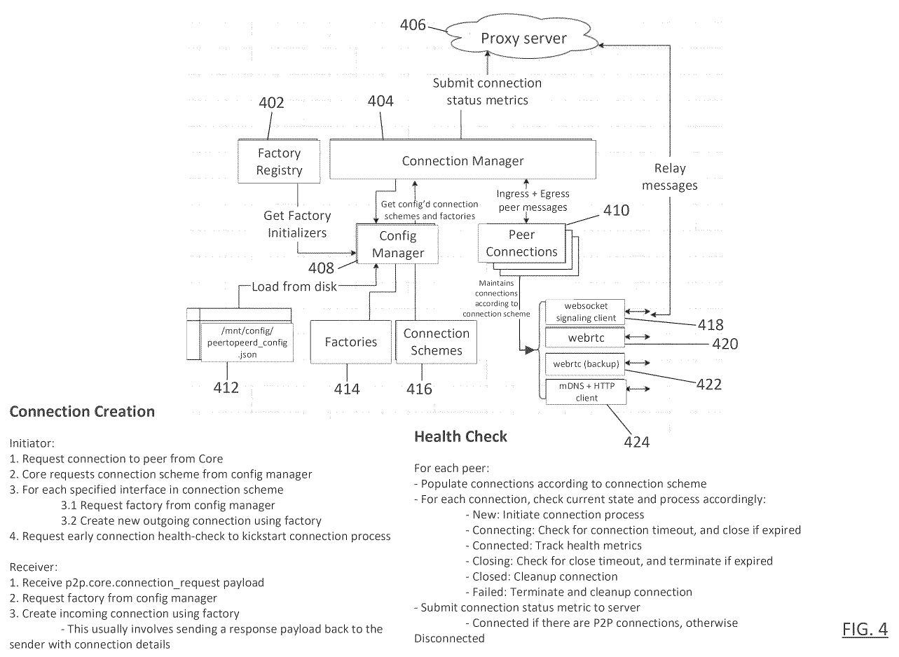

FIG. 4 illustrates a block diagram for P2P connections, according to an embodiment. FIG. 4 includes proxy server 406, factory registry 402, connection manager 404, configuration manager 408, peer connections 410, disk 412, factories 414, connection schemas 416, websocket signaling client 418, webrtc 420, webrtc (backup) 422, and mDNS+HTTP client 424. In addition to, or as an alternative to, connection schemas 416, the system of FIG. 4 may include one or more policies, one or more prioritized execution policies, one or more target connectivity profiles, prioritization logic, etc., as described herein.

Configuration manager 408 can be configured to receive connection schemes from connection schemes 416, factories from factories 414, and factory initializers from factory registry 402. Connection manager 404 can receive connection schemes and factories from configuration manager 408. Connection manager can also receive ingress and/or egress peer messages from peer connections 410. Peer connections 410 can maintain connections according to one or more connection schemes via, for example, a websocket signaling client 418, webrtc 420, webrtc (backup), and/or mDNS +HTTP client 424. Connection manager 404 can also submit connection status metrics to proxy server 406, and proxy server 406 can relay messages (e.g., status metrics, connection request, connection responses, etc.) to websocket signaling client 418, webrtc 420, webrtc (backup), and/or mDNS+HTTP client 424. In some implementations, connection schemes received from connection schemes 416 and factories received from factories 414 are stored in memory (e.g., memory 104 and/or 124) after being loaded from disk 412.

In some implementations, factories and initializers describe the way in which a connection of a given type/transport comes into existence. In some implementations, disk 412 stores a configuration that includes a list of factories 414 that can be used to populate the schema (e.g., enabled transport types). Connection schemes 416 can represent the schema to follow when creating new/additional transports for a given logical connection to a peer device. Factory registry 402 can represent a registry of initializers that can be used to create connections/transports of a given type. In some implementations, everything illustrates at FIG. 4 except proxy server 406 can be part of/stored at a peer compute device(s) (e.g., peer compute device 100 and/or 120).

To provide an example, a diamond can be configured so that the diamond is able to use WebRTC connections. A WebRTC connection initializer is register with factory registry 402 at startup. Connection schemes 416 describes that a desired connection state includes two connections of type WebRTC. Connection manager 404 then instantiates two of these connections using the register initializer from factory registry 402 and using the factory parameters described in factories 414. If the transport type is not described in factories 414, initialization does not occur. Instantiated connections can be managed as a logical connection by peer connections 410.

### Connection Creation—Initiator

In some implementations, connection creation from the initiator-side (e.g., peer compute device 100 and/or 120) can include a core module requesting connection to a peer compute device (e.g., peer compute device 100 and/or 120). The core can request a connection scheme from the configuration manager, which can include requesting a connection factory from the configuration manager and/or creating a new outgoing connection using the factory. The core can also request an early connection health-check to kickstart the connection process.

### Connection Creation—Receiver

A connection manager can receive a p2p.core.connection_request payload. The connection manager can request a factory from the configuration manager. The configuration manager can create an incoming connection using the factory, which can include sending a response payload back to the sender/initiator with connection details.

### Health Check

Each peer compute device can populate connections according to a connection scheme (e.g., prioritized execution policy 106). For each populated connection, the current state and process can be checked (e.g., proxy compute device and/or peer compute devices 100 and 120 could each check on the state of a shared webRTC channel; peer compute devices 100 and/or 120 could each check on the state of a shared webRTC channel without proxy compute device checking on the state of the shared webRTC channel). Examples of states include new, connecting, connected, closing, closed, failed, and/or the like. If the state is new, a connection process can be initiated (e.g., by a peer compute device or proxy compute device). If the state is connecting, a check can be made for whether there is a connection timeout and the connection can be closed if there is a connection timeout (e.g., by a peer compute device or proxy compute device). If the state is connected, health metrics can be tracked (e.g., by a peer compute device or proxy compute device). If the state is closing, a check can be made for close timeouts (e.g., by a peer compute device or proxy compute device); if the timeout is expired, the connection can be terminated (e.g., by a peer compute device or proxy compute device). If the state is closed, connection cleanup can occur (e.g., by a peer compute device or proxy compute device, optionally automatically, without further human intervention). As used herein, “connection cleanup” can refer to any processes/actions/operations that close and cleanup connection resources, for example including one or more of: initiating a teardown/close sequence, notifying peers of connection closure (assuming a graceful closure), freeing allocated structures and resources, unbinding sockets, releasing/closing file descriptors, clearing/freeing transmission buffers, etc. If the state is failed, the connection can be terminated and cleaned up (e.g., by a peer compute device or proxy compute device). In some implementations, the status(es) can be sent to a server (e.g., proxy compute device 160).

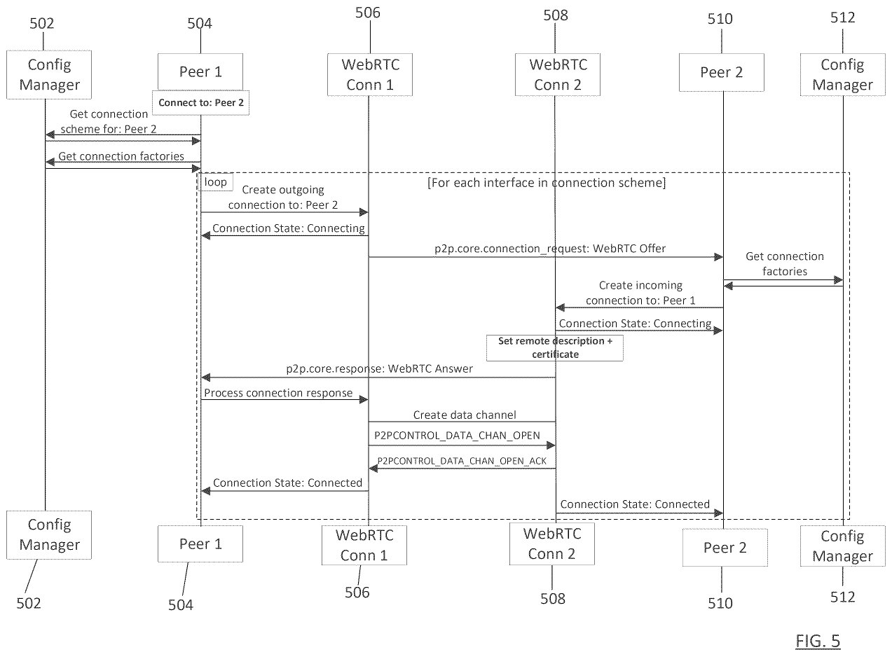

FIG. 5 illustrates a flow diagram to establish a connection, according to an embodiment. In some implementations, configuration manager 502 is a module at peer 1 504, webRTC connection 1 506 is a transport, and peer 1 504 is a peer compute device (e.g., peer compute device 100 and/or 120). In some implementations, configuration manager 512 is a module at peer 2 510, webRTC connection 2 508 is a transport, and peer 2 510 is a peer compute device (e.g., peer compute device 100 and/or 120). In some implementations, webRTC connection 1 506 is instantiated/comes into existence at, and in response to, the start of an operational loop as described herein, e.g., the process(es) discussed below.

Peer 1 504 requests to connect to peer 2 510. Peer 1 504 loads configuration manger 502 when peer 1 504 is creating a connection and/or responding to a connection request. Peer 2 510 loads configuration manager 512 when peer 2 510 is creating a connection and/or responding to a connection request. The aforementioned process of receiving and/or sending a connection scheme (e.g., prioritized execution policy 106) and connection factory can occur for each interface in the connection scheme. Peer 1 504 can create an outgoing connection to peer 2 501 using webRTC connection 1 506. WebRTC connection 1 506 can return a connection state of “connecting” to peer 1 504. WebRTC connection 1 506 can send a “p2p.core.connection_request: WebRTC Offer” command (e.g., a description of the payload for the “p2p.core.connection_request” command) to Peer 2 510. Peer 2 510 can request and receive connection factories from configuration manager 512. Peer 2 510 can create an incoming connection to peer 1 504 using webRTC connection 2 508, and peer 2 510 can receive a connection state of “connecting” from webRTC connection 2 508. WebRTC can set a remote description and certificate. WebRTC connection 2 508 can send a “p2p.core.response: WebRTC Answer” command to peer 1 504. Peer 1 504 can send a process connection response to webRTC connection 1 506. A data channel can be created between webRTC connection 1 506 and webRTC connection 2 508. WebRTC connection 1 506 can send a “P2PCONTROL_DATA_CHAN_OPEN” command to webRTC connection 2 508, and webRTC connection 2 508 can send a “P2PCONTROL_DATA_CHAN_OPEN_ACK” command to webRTC connection 1 506. WebRTC connection 1 506 can then send a connection status of “connected” to peer 1 504. WebRTC connection 2 508 can send a connection status of “connected” to peer 2 510.

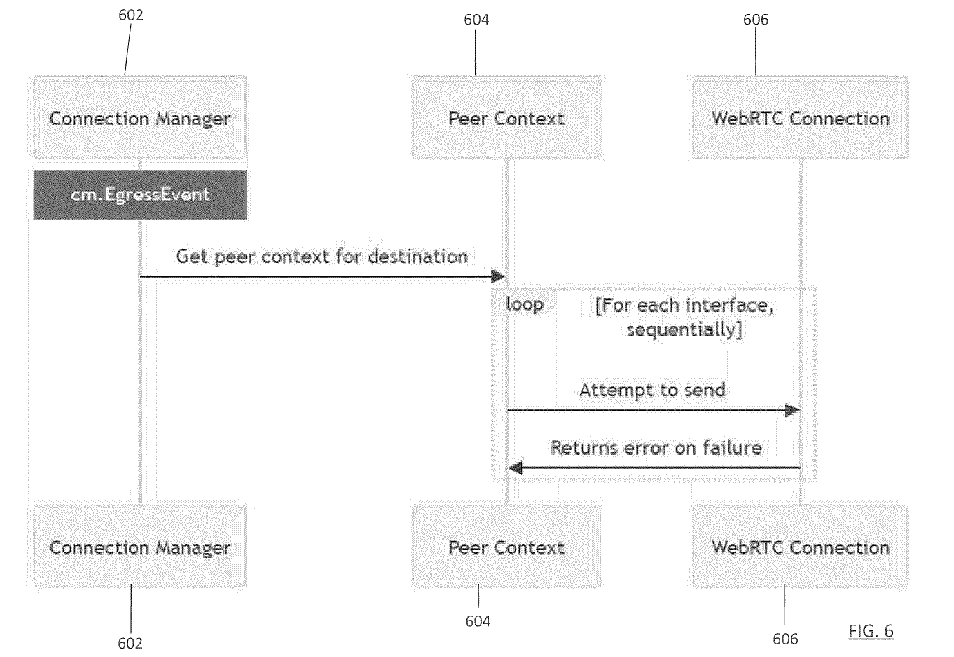

FIG. 6 illustrates a message egress flow diagram, according to an embodiment. Connection manager 602 identifies/looks up peer context for a destination (e.g., finding peer context for a given peer compute data to send data to). Then, sequentially for each interface, peer context 604 attempts to send, and webRTC connection 606 returns, an indication of error on failure. In some implementations, connection manager 602, peer context 604, and/or webRTC connection 606 are modules of a peer compute device (e.g., peer compute device 100 and/or 120). WebRTC connection 606 is an example of a transport type that can be used, however other implementations can alternatively or additionally use one or more other types of real transport.

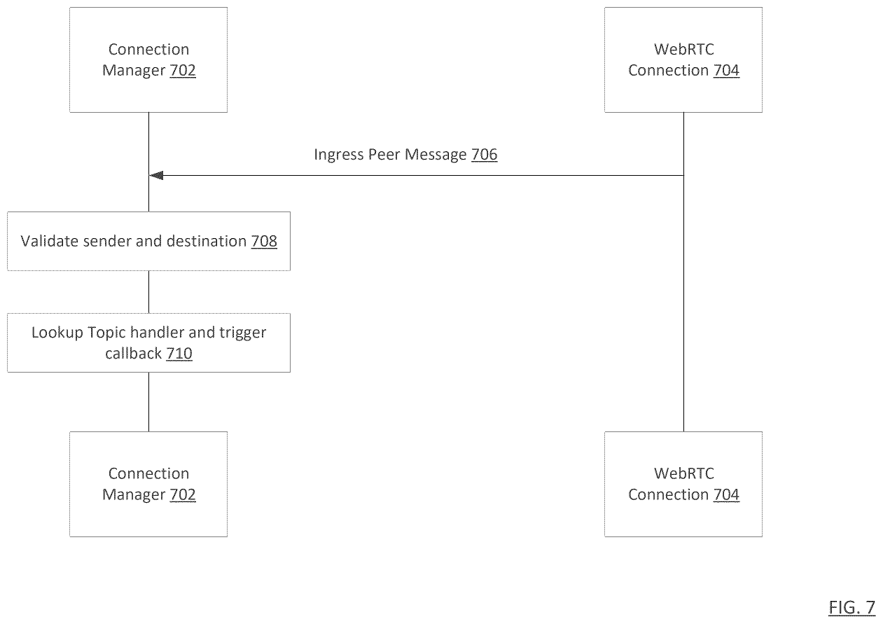

FIG. 7 illustrates a message ingress flow diagram, according to an embodiment. Connection manager 702 can be stored at a compute device (e.g., peer compute device 100 or 120) that uses a webRTC connection 704. Connection manager 702 can receive an ingress peer message 706 via webRTC connection 704, validate the sender and the destination peer compute device(s) at 708, and at 710 lookup a topic handler and trigger callback.

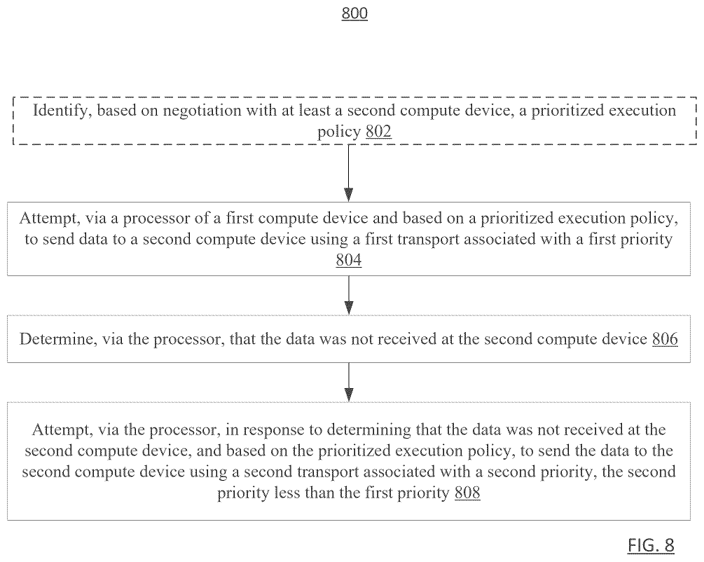

FIG. 8 illustrates a flow diagram of a method 800 to attempt establishing a connection using multiple transports, according to an embodiment. In some implementations, method 800 is performed by a processor (e.g., processor 102 and/or 122). At 802, a prioritized execution policy is optionally identified, based on a negotiation with at least a second compute device. At 804, an attempt is made, by a first compute device (e.g., peer compute device 100) and based on a prioritized execution policy (e.g., prioritized execution policy 106), to send data to a second compute device (e.g., peer compute device 120) using a first transport associated with a first priority. At 806, a determination is made that the data was not received at the second compute device. At 808, in response to determining that the data was not received at the second compute device, an attempt is made, based on the prioritized execution policy, to send the data to the second compute device using a second transport associated with a second priority that is less than the first priority. In some implementations of method 800, at least one of the first transport or the second transport is at least one of a websocket proxy transport that proxies the data through a third compute device, a real-time communication data channel transport, or a transport that uses multicast domain name system (mDNS) to determine an internet protocol (IP) address associated with the second compute device and hypertext transfer protocol secure (HTTPS) to attempt communication with the second compute device.

In some implementations, rather than creating one transport at a time and attempting to use that transport, multiple transports are created simultaneously and used to connect to the peer compute device(s) After creating the multiple transports, the transports are used sequentially (e.g., based on a priority) when attempting to actually send data from a first peer compute device to a second peer compute device. Stated another way, the step(s) involved with establishing a connection(s) may be separated in time from and/or performed prior to the sending of (or attempts to send) data.

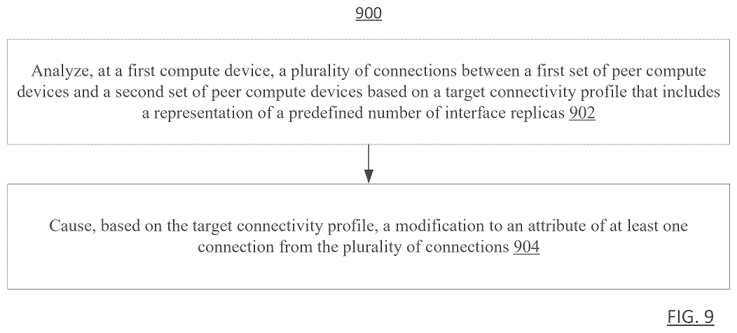

FIG. 9 illustrates a flow diagram of a method 900 to analyze attributes of connections, according to an embodiment. In some implementations, method 900 is performed by a processor (e.g., processor 102 and/or 122).

At 902, a plurality of connections between a first set of peer compute devices (e.g., that include peer compute device 100) and a second set of peer compute devices (e.g., that include peer compute device 120) are analyzed, by a first compute device (e.g., peer compute device 100 and/or 120), based on a schema (e.g., prioritized execution policy 106) indicating predetermined target attributes for the plurality of connections. The target attributes include a predetermined number of interface replicas. At 904, an attribute of at least one connection from the plurality of connection is caused, based on the schema, to be modified.

In some implementations of method 900, each connection from the plurality of connections uses a network protocol different than remaining connections from the plurality of connections.

In some embodiments, a method includes attempting, via a processor of a first compute device and based on a prioritized execution policy, to send data to a second compute device using a first transport associated with a first priority. The method also includes determining, via the processor, that the data was not received at the second compute device. The method also includes attempting, via the processor, in response to determining that the data was not received at the second compute device, and based on the prioritized execution policy, to send the data to the second compute device using a second transport associated with a second priority, the second priority less than the first priority, the prioritized execution policy being implemented at least in part by a peer-to-peer daemon, the prioritized execution policy referencing a plurality of transports that includes the first transport, the second transport, and at least one further transport.

In some implementations, at least one of the first transport or the second transport includes at least one of: a proxy transport, a peer-to-peer communication data channel transport, wireless communications, or a local discovery transport. The local discovery transport may use multicast domain name system (mDNS) to determine an internet protocol (IP) address associated with the second compute device and hypertext transfer protocol secure (HTTPS) to attempt communication with the second compute device.

In some such implementations, the at least one of the first transport or the second transport includes the proxy transport, and the proxy transport is configured to proxy the data through a third compute device.

In some such implementations, the at least one of the first transport or the second transport includes the proxy transport, and the proxy transport includes at least one of a websocket proxy server, a TURN server, a relay server, a cloud gateway or an overlay network.

In some such implementations, the at least one of the first transport or the second transport includes the peer-to-peer communication data channel transport, and the peer-to-peer communication data channel transport is a real-time peer-to-peer communication data channel transport.

In some such implementations, the at least one of the first transport or the second transport includes the peer-to-peer communication data channel transport, and the peer-to-peer communication data channel transport includes at least one of a WebRTC data channel transport, QUIC, HTTP3, a raw Transmission Control Protocol (TCP) channel, or a raw User Datagram Protocol (UDP) channel.

In some such implementations, the at least one of the first transport or the second transport includes the local discovery transport, and the local discovery transport is configured to use (1) multicast domain name system (mDNS) to determine an internet protocol (IP) address associated with the second compute device and (2) hypertext transfer protocol secure (HTTPS) to attempt communication with the second compute device.

In some embodiments, a non-transitory, processor-readable medium stores instructions that, when executed by a processor, cause the processor to analyze, at a first compute device, a plurality of connections between a first set of peer compute devices and a second set of peer compute devices based on a target connectivity profile that includes a representation of a predefined number of interface replicas. The instructions also include instructions that, when executed by a processor, cause the processor to cause, based on the target connectivity profile, a modification to an attribute of at least one connection from the plurality of connections.

In some implementations, each connection from the plurality of connections uses a network protocol different than remaining connections from the plurality of connections. Alternatively, in some implementations, two or more connections from the plurality of connections may use a common network protocol or network protocol type.

In some implementations, the target connectivity profile also includes a representation of at least one of a target state associated with at least one connection from the plurality of connections, a number of connections associated with at least one connection from the plurality of connections, a latency associated with at least one connection from the plurality of connections, or a last response time associated with at least one connection from the plurality of connections.

In some implementations, the target connectivity profile is a user-defined target connectivity profile.

In some implementations, the instructions also store instructions to cause the processor to define the target connectivity profile based on at least one transport health metric associated with at least one connection from the plurality of connections. The at least one transport health metric can include at least one of a latency, a last connection, a last response time, an uptime, a roundtrip time, a number of hops, a fewest hops metric, or a signal strength.

In some implementations, the instructions further store instructions to cause the processor to at least one of: (a) automatically populate at least a subset of connections from the plurality of connections; (b) automatically configure a plurality of interfaces associated with the plurality of connections; or (c) monitor health metrics of connections from the plurality of connections based on a prioritized execution policy.

In various embodiments, a policy (such as a prioritized execution policy) and/or a target connectivity profile can be defined using one or more of the following methods: pushed/sent from a central server to the peer compute device(s), pulled/received from a central server by the peer compute device(s), stored on disk at the peer compute device(s), read into memory at the peer compute device(s), downloaded into memory of the peer compute device(s) only, negotiated between/among the peer compute device(s), configured by an API/manager/environment, etc.

In some embodiments, a non-transitory, processor-readable medium storing instructions that, when executed by a processor, cause the processor to identify, based on negotiation with at least a second compute device, a prioritized execution policy that includes a representation of a customizable number of interface replicas. The processor-readable medium also stores instructions that, when executed by a processor, cause the processor to attempt, at a first compute device and based on the prioritized execution policy, to send data to the second compute device using a first transport associated with a first priority. The processor-readable medium also stores instructions that, when executed by a processor, cause the processor to determine that the data was not received at the second compute device. The processor-readable medium also stores instructions that, when executed by a processor, cause the processor to attempt, in response to determining that the data was not received at the second compute device, and based on the prioritized execution policy, to send the data to the second compute device using a second transport associated with a second priority, the second priority less than the first priority.

In some implementations, at least one of the first transport or the second transport includes a proxy transport configured to proxy the data through a third compute device.

In some implementations, at least one of the first transport or the second transport includes a proxy transport that includes at least one of a websocket proxy server, a TURN server, a relay server, a cloud gateway or an overlay network.

In some implementations, at least one of the first transport or the second transport includes a peer-to-peer communication data channel transport.

In some implementations, the peer-to-peer communication data channel transport is a real-time peer-to-peer communication data channel transport.

In some implementations, at least one of the first transport or the second transport includes a peer-to-peer communication data channel transport that includes at least one of a WebRTC data channel transport, QUIC, HTTP3, a raw Transmission Control Protocol (TCP) channel, or a raw User Datagram Protocol (UDP) channel.

Combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. As such, all examples and/or embodiments are deemed to be non-limiting throughout this disclosure.

It is to be understood that the logical and/or topological structure of any combination of any program components (a component collection), other components and/or any present feature sets as described in the Figures and/or throughout are not limited to a fixed operating order and/or arrangement, but rather, any disclosed order is an example and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting.

What is claimed is:

1. A method, comprising:
attempting, via a processor of a first compute device and based on a prioritized execution policy, to send data to a second compute device using a first transport associated with a first priority;
determining, via the processor, that the data was not received at the second compute device; and
attempting, via the processor, in response to determining that the data was not received at the second compute device, and based on the prioritized execution policy, to send the data to the second compute device using a second transport associated with a second priority, the second priority less than the first priority, the prioritized execution policy being implemented at least in part by a peer-to-peer daemon, the prioritized execution policy referencing a plurality of transports that includes the first transport, the second transport, and at least one further transport.

2. The method of claim 1, wherein at least one of the first transport or the second transport includes at least one of: a proxy transport, a peer-to-peer communication data channel transport, wireless communications, or a local discovery transport.

3. The method of claim 2, wherein the at least one of the first transport or the second transport includes the proxy transport, and the proxy transport is configured to proxy the data through a third compute device.

4. The method of claim 2, wherein the at least one of the first transport or the second transport includes the proxy transport, and the proxy transport includes at least one of a websocket proxy server, a TURN server, a relay server, a cloud gateway or an overlay network.

5. The method of claim 2, wherein the at least one of the first transport or the second transport includes the peer-to-peer communication data channel transport, and the peer-to-peer communication data channel transport is a real-time peer-to-peer communication data channel transport.

6. The method of claim 2, wherein the at least one of the first transport or the second transport includes the peer-to-peer communication data channel transport, and the peer-to-peer communication data channel transport includes at least one of a WebRTC data channel transport, QUIC, HTTP3, a raw Transmission Control Protocol (TCP) channel, or a raw User Datagram Protocol (UDP) channel.

7. The method of claim 2, wherein the at least one of the first transport or the second transport includes the local discovery transport, and the local discovery transport is configured to use (1) multicast domain name system (mDNS) to determine an internet protocol (IP) address associated with the second compute device and (2) hypertext transfer protocol secure (HTTPS) to attempt communication with the second compute device.

8. A non-transitory, processor-readable medium storing instructions that, when executed by a processor, cause the processor to:
analyze, at a first compute device, a plurality of connections between a first set of peer compute devices and a second set of peer compute devices based on a target connectivity profile that includes a representation of a predefined number of interface replicas; and
cause, based on the target connectivity profile, a modification to an attribute of at least one connection from the plurality of connections.

9. The non-transitory, processor-readable medium of claim 8, wherein each connection from the plurality of connections uses a network protocol different than remaining connections from the plurality of connections.

10. The non-transitory, processor-readable medium of claim 8, wherein the target connectivity profile further includes a representation of at least one of a target state associated with at least one connection from the plurality of connections, a number of connections associated with at least one connection from the plurality of connections, a latency associated with at least one connection from the plurality of connections, or a last response time associated with at least one connection from the plurality of connections.

11. The non-transitory, processor-readable medium of claim 8, wherein the target connectivity profile is a user-defined target connectivity profile.

12. The non-transitory, processor-readable medium of claim 8, wherein the instructions further store instructions to cause the processor to define the target connectivity profile based on at least one transport health metric associated with at least one connection from the plurality of connections.

13. The non-transitory, processor-readable medium of claim 12, wherein the at least one transport health metric includes at least one of a latency, a last connection, a last response time, an uptime, a roundtrip time, a number of hops, a fewest hops metric, or a signal strength.

14. The non-transitory, processor-readable medium of claim 8, wherein the instructions further store instructions to cause the processor to at least one of:
automatically populate at least a subset of connections from the plurality of connections;
automatically configure a plurality of interfaces associated with the plurality of connections; or
monitor health metrics of connections from the plurality of connections based on a prioritized execution policy.

15. A non-transitory, processor-readable medium storing instructions that, when executed by a processor, cause the processor to:
identify, based on negotiation with at least a second compute device, a prioritized execution policy that includes a representation of a customizable number of interface replicas;
attempt, at a first compute device and based on the prioritized execution policy, to send data to the second compute device using a first transport associated with a first priority;
determine that the data was not received at the second compute device; and
attempt, in response to determining that the data was not received at the second compute device, and based on the prioritized execution policy, to send the data to the second compute device using a second transport associated with a second priority, the second priority less than the first priority.

16. The non-transitory, processor-readable medium of claim 15, wherein at least one of the first transport or the second transport includes a proxy transport configured to proxy the data through a third compute device.

17. The non-transitory, processor-readable medium of claim 15, wherein at least one of the first transport or the second transport includes a proxy transport that includes at least one of a websocket proxy server, a TURN server, a relay server, a cloud gateway or an overlay network.

18. The non-transitory, processor-readable medium of claim 15, wherein at least one of the first transport or the second transport includes a peer-to-peer communication data channel transport.

19. The non-transitory, processor-readable medium of claim 18, wherein the peer-to-peer communication data channel transport is a real-time peer-to-peer communication data channel transport.

20. The non-transitory, processor-readable medium of claim 15, wherein at least one of the first transport or the second transport includes a peer-to-peer communication data channel transport that includes at least one of a WebRTC data channel transport, QUIC, HTTP3, a raw Transmission Control Protocol (TCP) channel, or a raw User Datagram Protocol (UDP) channel.
